(19) United States
(12) Patent Application Publication
(10) Pub. No.: US 2005/0061170 A1
(43) Pub. Date: Mar. 24, 2005

(54) Methods and apparatus for decorating items

(76) Inventor: Giancarlo Fenzi, Soave (IT)

Correspondence Address: NIXON & VANDERHYE, PC, 1100 N GLEBE ROAD, 8TH FLOOR, ARLINGTON, VA, 22201-4714, US

(21) Appl. No.: 10/502,544

(22) PCT Filed: Feb. 3, 2004
(86) PCT No.: PCT/IB04/00046

(30) Foreign Application Priority Data
Feb. 3, 2003 (IT) MO2003A000022

(51) Int. Cl. B41F 7/02

(52) U.S. Cl. 101/217

(57) ABSTRACT

Apparatus comprises transfer means (14; 32; 54) suitable for coming into contact with a shaped surface (2′; 55, 58) of an item (1′; 44; 44′) to transfer thereupon a fluid material (7, 7′) and applicator means (19; 38) suitable for applying said fluid material (7, 7′) onto said transfer means (14; 32; 54), said transfer means (14; 32; 54) being deformable in such a way as to be able to adapt itself according to said shaped surface (2′; 55, 58).

Method for decorating an item (1, 1′) comprises distributing onto said item (1, 1′) a polymeric base layer means (3), applying onto said base layer means (3) a decorative pattern defined by decorating means (4, 7, 7′) in liquid form, fixing said decorative pattern to said item (1, 1′), said fixing comprising anchoring said decorating means (4, 7, 7′) to said base layer means (3), without applying to said item (1, 1′) further fixing layers.

The invention concerns methods and an apparatus for decorating a surface of an item, in particular a section bar or a piece of sheet metal.

Methods are known that enable a multilayered decoration to be applied to a flat surface of an item, reproducing for example the veins of wood or marble.

According to such methods, after first preparing the surface of the item to receive the layers that make up the decoration, a bottom layer must be applied that will constitute the basic colour of the decoration. The item coated with the bottom layer is heated to the temperature of polymerisation of the material constituting said layer and maintained at that temperature for a set time. In such conditions, the material of the bottom layer undergoes a reticulation process and as it sets it stably grips the surface of the item.

On the set bottom layer, a decorative layer is then applied according to a desired decorative pattern, for example to reproduce the veins of a certain type of wood.

The decorative layer is not in itself sufficiently cohesive and is made to adhere to the bottom layer by means of the application of a final layer that covers both the layers underneath and by means of final heat treatment of the item coated with the three layers. This heat treatment occurs for a time and at a temperature that enable polymerisation of the final layer, which enables the decorative layer to be anchored to the bottom layer.

The final layer is transparent, in such a way as to keep the decoration below visible.

One defect of the prior-art methods is that in order to obtain a decorated item, at least three layers must be applied. This involves great consumption of material, prolonged processing time and the need to use particular equipment to apply each layer.

Furthermore, the item must be subjected to two heat treatments that enable the bottom layer and the final layer to polymerise completely. The decoration procedure requires enormous energy and rather great time consumption, which is responsible for high production costs.

Furthermore, the aesthetic result is not satisfactory because the final layer applied evenly to the entire surface of the item gives the decoration an unnatural flattened appearance. This is not desired when the decoration has to reproduce the appearance of a surface of wood or marble or of any other natural material.

Another disadvantage of the prior art is that it is apt to be applied only to the flat surfaces of an item. It is in fact rather difficult to apply the decorating material to the concave or convex zones of the item to be decorated, where it is almost impossible to obtain good resolution. Similar disadvantages occur if surfaces have to be decorated having grooves, protrusions or recesses, or edge zones of items such as section bars or sheet metal.

One object of the invention is to improve the methods and apparatuses for decorating items, in particular sheet metal and section bars.

A further object is to supply methods and apparatuses that enable non-flat surfaces to be decorated.

A yet further object is to provide a method for decorating an item that involves reduced consumption of material applied to the surface of the item to be decorated.

Another object is to provide a method for decorating an item that requires fast execution time and low energy consumption. In a first aspect of the invention, an apparatus is provided comprising transfer means suitable for coming into contact with a shaped surface of an item to transfer thereupon a fluid material and applicator means suitable for applying said fluid material onto said transfer means, characterised in that said transfer means is deformable so as to be able to adapt itself according to said shaped surface.

In a second aspect of the invention a method is provided comprising bringing transfer means into contact with a shaped surface of an item to transfer a fluid material from said transfer means to said shaped surface, characterised in that during said transferring said transfer means is deformed to adapt itself to said shaped surface.

Owing to these aspects of the invention, a fluid material can be applied to a shaped surface of an item, such a surface being shaped even according to a complicated geometry, for example having a curved profile or provided with recesses or reliefs. In fact, thanks to its deformability, when transfer means interacts with the shaped surface of the item, it can be deformed according to the geometry of the shaped surface and also apply the fluid material even to points situated at different heights from one another.

The apparatus and the method according to these aspects of the invention enable in particular the fluid material to be applied to edge zones of an item, such as, for example, zones arranged on the edges of a main substantially flat surface of this item.

According to a third aspect of the invention, a method is provided for decorating an item, comprising distributing on said item polymeric base layer means, applying onto said base layer means a decorative pattern defined by decorating means in liquid form, fixing said decorative pattern to said item, characterised in that said fixing comprises anchoring said decorating means to said base layer means, without applying further fixing layers to said item.

Owing to this aspect of the invention, it is possible to obtain a decorating method that enables the number of layers deposited to the surface of the decorated item to be limited.

In fact, no fixing means is provided that is additional to base layer means and to decorating means, and in particular recourse to the transparent layer provided for in the prior art is eliminated. In this way, it is possible to reduce consumption of the material to be applied to the item and to make decorating operations faster.

Furthermore, the decorative pattern takes on a more pleasant and natural appearance as it does not appear ‘flattened’ by additional fixing layers.

In a fourth aspect of the invention, the use of a paint that is settable by means of UV rays for decorating a section bar is provided.

Owing to the fourth aspect of the invention, section bars can be recovered that have been decorated to a poor level of quality in order to decorate them again. In fact, if the decoration is found to be of poor quality, the paint can be removed by means of a suitable solvent before being set by UV rays. The section bar, from which the paint has been removed, can then be decorated again to the desired quality. It is thereby no longer necessary to reject and then throw away the section bars decorated in an unsatisfactory manner.

In a fifth aspect of the invention, the use of a relief printing technique for decorating section bars is provided.

In a sixth aspect of the invention, the use of a gravure printing technique for decorating section bars is provided.

Owing to the fifth and sixth aspects of the invention, it is possible to obtain a particularly wide range of decorative effects associated with an excellent print definition.

The invention may be better understood and implemented by referring to the attached drawings that illustrate some non-limiting examples of embodiments, wherein:

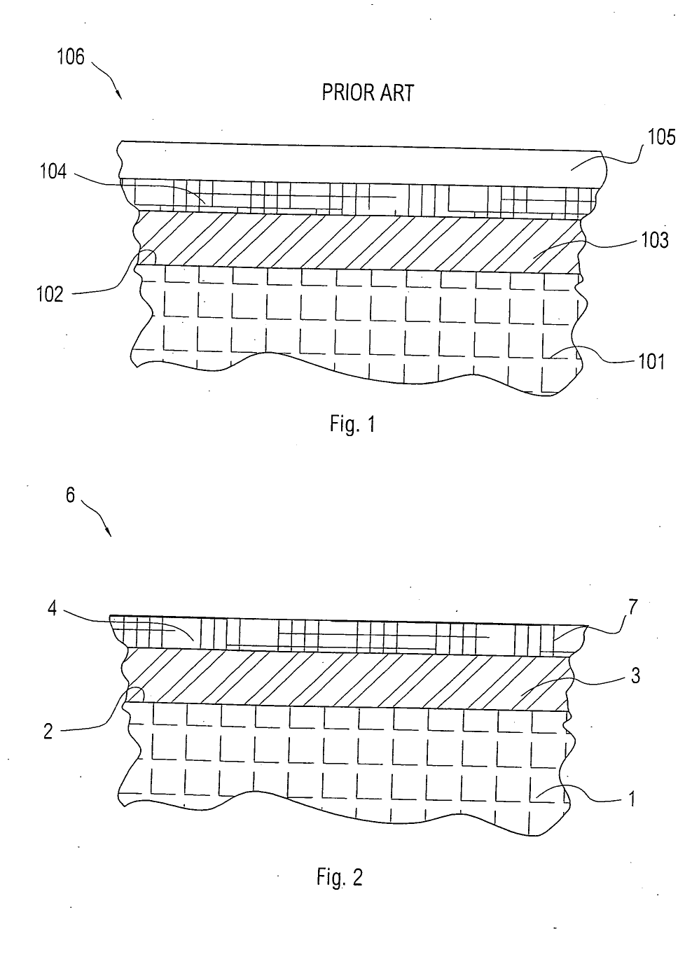

FIG. 1 is an enlarged and interrupted section of a decorated surface of an item, according to the prior art;

FIG. 2 is an enlarged and interrupted section of a decorated surface of an item;

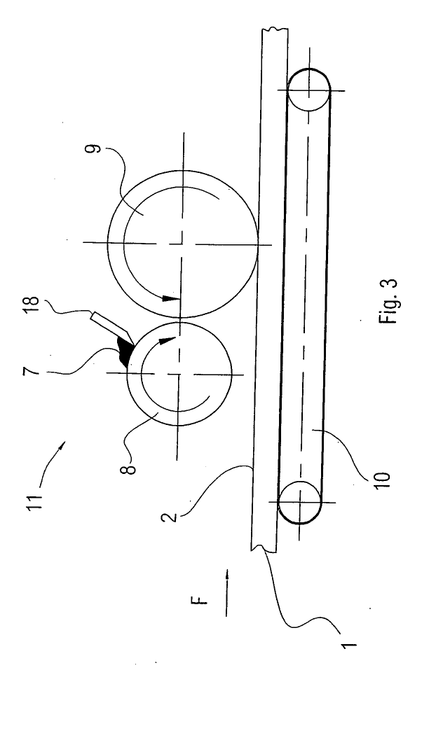

FIG. 3 is a schematic view of a first apparatus for decorating items;

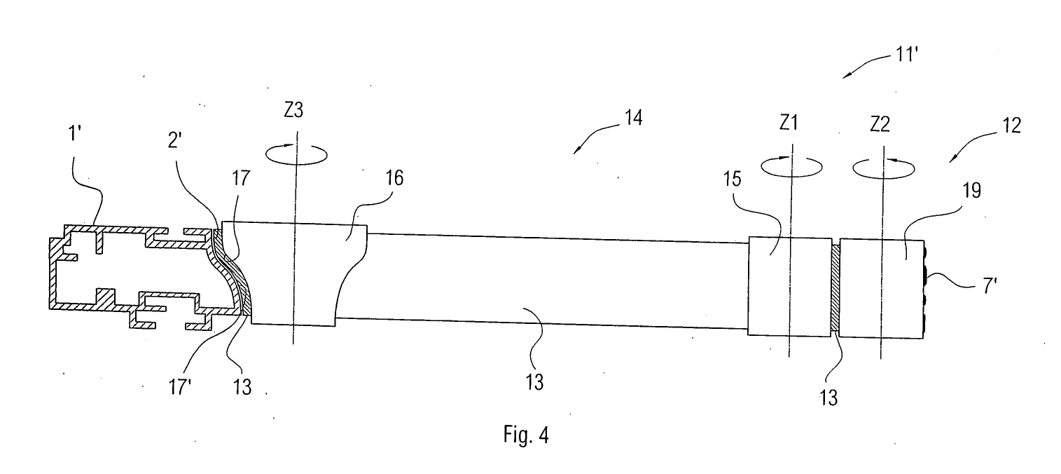

FIG. 4 is a partially sectioned schematic view of a second apparatus for decorating items;

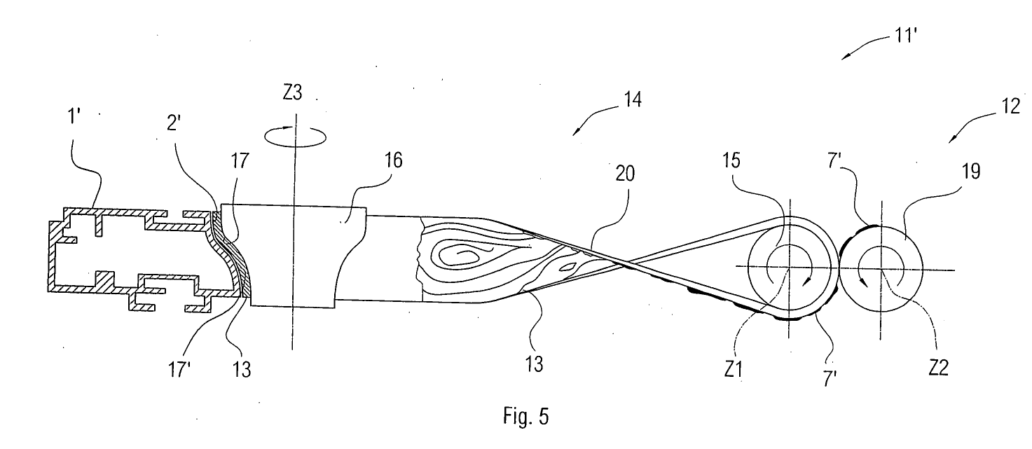

FIG. 5 is a partially sectioned schematic view of an alternative configuration of the apparatus in FIG. 4;

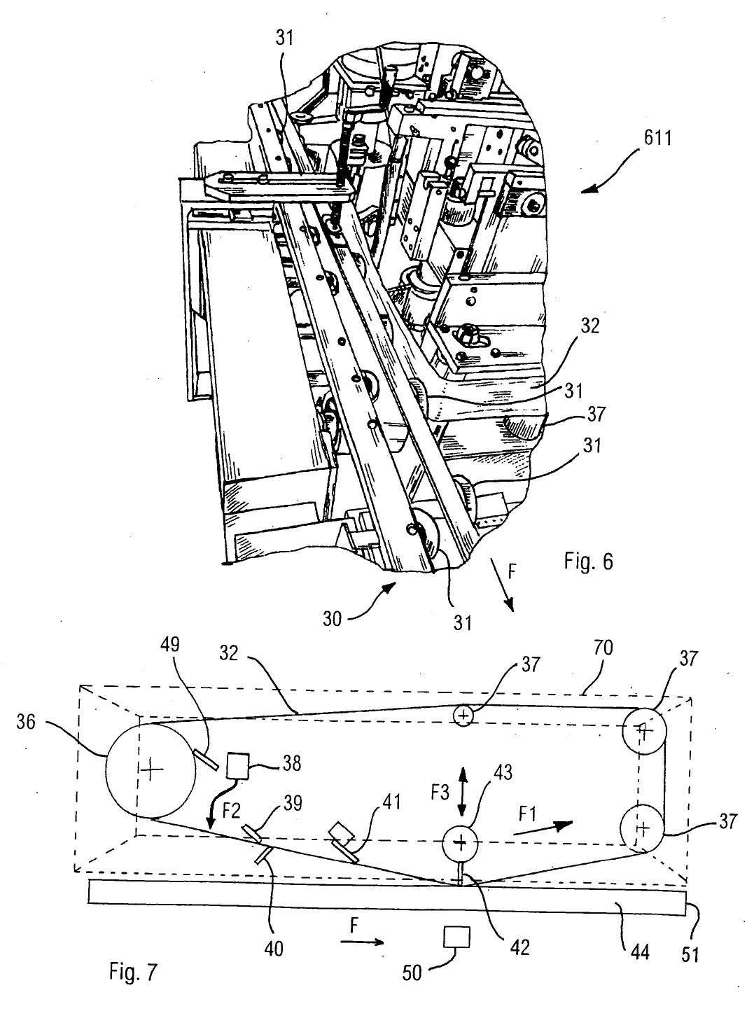

FIG. 6 is a perspective and interrupted view of a third apparatus for decorating items;

FIG. 7 is a schematic plan view of the apparatus in FIG. 6;

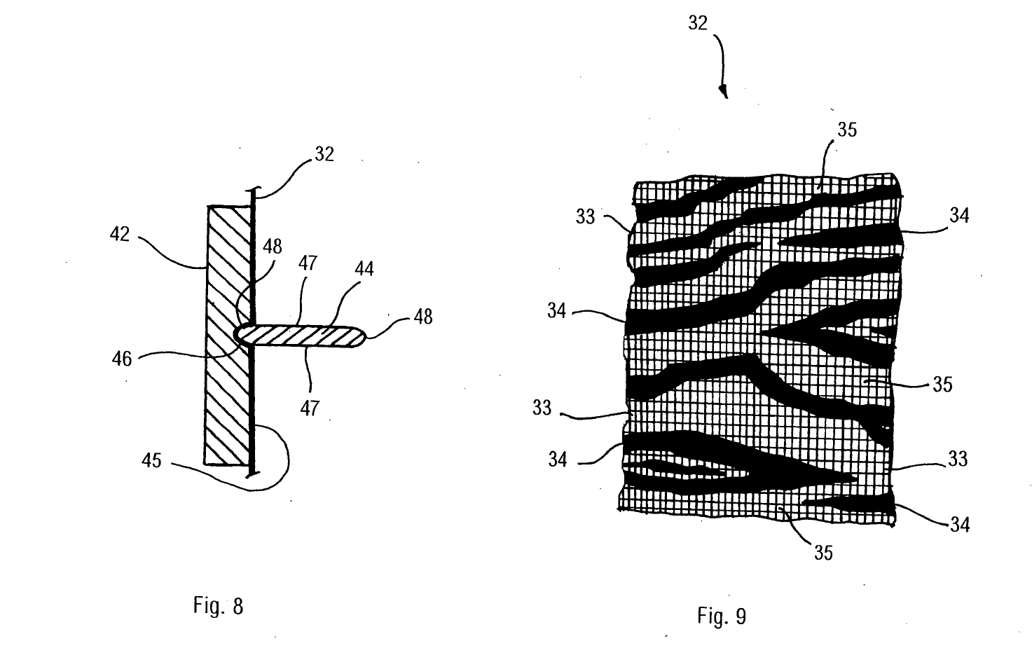

FIG. 8 is a schematic section of a portion of the apparatus in FIG. 6;

FIG. 9 is a schematic and enlarged view of a portion of transfer means of the apparatus in FIG. 6;

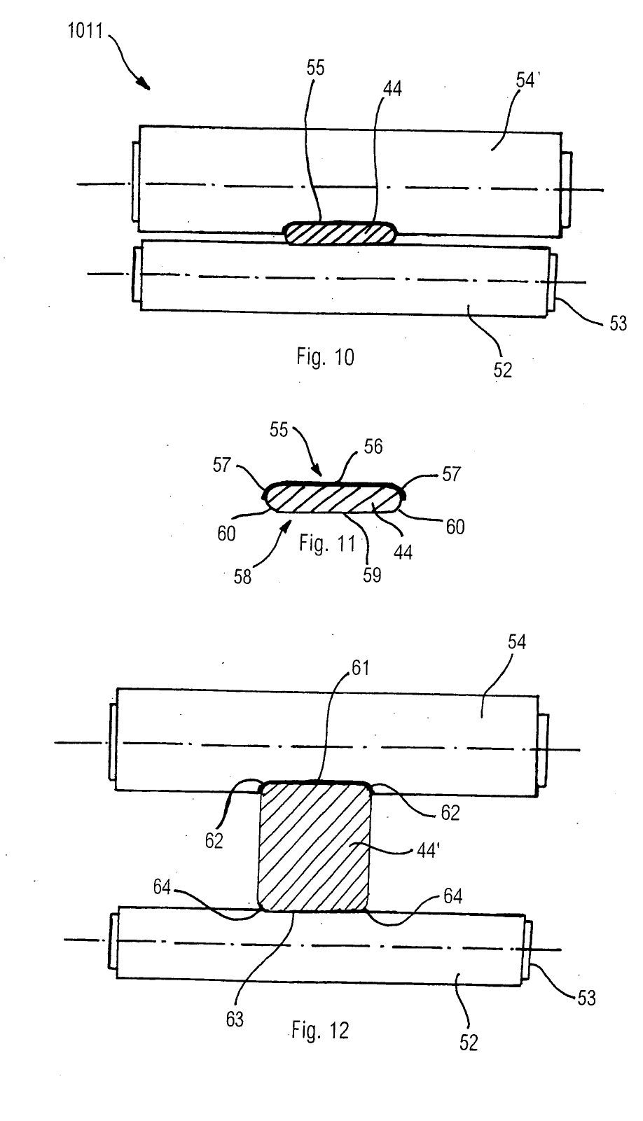

FIG. 10 is a schematic front view of a fourth apparatus for decorating a section bar with an oval cross-section;

FIG. 11 is a schematic cross-section of a section bar decorated with the apparatus in FIG. 10;

FIG. 12 is a view like the one in FIG. 10, wherein the apparatus is used for decorating a section bar with a substantially square cross-section.

FIG. 1 shows an item 101 having a surface 102 with a multilayered decoration 106 obtained by means of a prior-art method. On the surface 102, a bottom layer 103 is first applied that defines the colour on the basis of the desired decoration. The item 101 covered by the bottom layer 103 is inserted into a heating apparatus that is not shown and is subjected to a first heating cycle that causes substantially complete firing. To the bottom layer 103 a coloured layer 104 is then deposited to which a final transparent layer 105 is deposited. The latter acts as fixing means that makes the coloured layer 104 integral with the bottom layer 103 after the item 101 covered by the three layers described above is subjected to a second heating cycle to polymerise the final transparent layer 105.

In FIG. 2 an item 1 is shown, for example a section bar or sheet metal, the surface 2 of which is covered with a multilayered decoration 6 comprising a bottom layer 3 and a decorative layer 4. The bottom layer 3 can be applied in the form of powder paint, for example of the thermosetting type, which covers the entire surface 2 evenly. The bottom layer 3 is applied using prior-art means, for example of the electrostatic or spray type.

However, it is also possible to apply the bottom layer 3 in the form of a liquid paint, for example, thermosetting.

The item 1 covered by the bottom layer 3 is then subjected to heat treatment at a temperature between 140° C. and approximately 180° C., for example 170° C., for about 10 minutes so as to obtain partial firing of the bottom layer 3. After this treatment, even if the bottom layer 3 has not undergone complete reticulation, the particles that make it up have acquired good cohesion between themselves. The bottom layer 3 can thus be an excellent support for the decorative layer 4, after acquiring good adhesive properties in relation to the decorative layer 4. Furthermore, to obtain partial firing of the bottom layer 3, lower energy consumption is necessary than would be necessary to obtain its complete firing.

Subsequently, the decorative layer 4 is applied by distributing on the bottom layer 3 a liquid decorative material 7 according to a desired decorative pattern. The liquid decorative material 7 may in particular be a thermosetting paint, applied by means of gravure printing or relief printing technique.

A phase of complete firing of item 1 covered by the partially polymerised bottom layer 3 and by the liquid decorating material 7 follows. In this phase, item 1 is maintained at a temperature between approximately 180° C. and approximately 220° C. for a time between 10 and 40 minutes.

The liquid decorating material 7 can also be a paint settable through exposure to UV rays. In this case, if the decorative layer 4 has faults, it is possible to remove the liquid decorating material 7 before exposure to UV rays by using a suitable solvent and then applying a new decorative layer 4 onto the same item 1. This enables the items to be recovered, and in particular the section bars, whereupon a low-quality decoration was erroneously applied, by decorating the items again until the desired quality of decoration is obtained.

The paint that is settable by UV rays can be used not only to decorate items according to the above method but can also be used in other known methods of decoration, particularly applied to section bars.

The liquid decorating material 7 can be applied by means of an apparatus 11 of the type shown in FIG. 3. The apparatus 11 comprises a feeder roller 8 suitable for applying the liquid decorating material 7 onto a decorating roller 9, whereupon the pattern is created that one wishes to transfer to the surface 2 of the item 1.

The decorating roller 9 can operate according to a relief printing or gravure printing principle.

In the example in FIG. 3, the decorating roller 9 operates according to a relief printing principle, wherein the liquid decorating material 7, by means of the feeder roller 8, is applied to a plurality of reliefs or protrusions provided on the external surface of the decorating roller 9 and arranged in such a manner as to define the desired pattern. The feeder roller 8 is of the reticulated type, in other words, it is provided with a plurality of cavities arranged in a regular manner wherein the liquid decorating material 7 is distributed. A doctor knife 18, operating in contact with the feeder roller 8, ensures that liquid decorating material 7 substantially fills all the cavities of the roller, at the same time keeping all the regions clean that separate adjacent cavities on the feeder roller 8.

The decorating roller 9 may be provided with an external layer in rubber, whilst the feeder roller 8 may be in steel, rubber, or another material.

In an embodiment that is not shown, the decorating roller 9 operates according to a rotogravure technique, in other words it receives the liquid decorating material 7 within a plurality of cavities with which the roller is externally equipped and transfers it to the surface 2, thereby forming a pattern defined by those cavities.

The rotation axis of the feeder roller 8 coincides with the geometrical axis of the roller itself and is substantially parallel to the rotation axis of the decorating roller 9, said axis also coinciding with the geometrical axis of the latter roller. The liquid decorating material 7 is transferred from the feeder roller 8 to the decorating roller 9 by contact between the two rollers rotating reciprocally: the rotating directions of each roller may be opposite, as shown in FIG. 3, or may be the same, depending on the quantity of liquid decorating material 7 that one wishes to apply to form the decorative layer 4. To obtain a relatively great thickness of the decorative layer 4, the rollers 8 and 9 rotate in opposite directions whereas to obtain a smaller thickness the rollers 8 and 9 rotate in the same direction.

The liquid decorating material 7 is applied by the decorating roller 9 to the item 1, which may, for example, be a section bar or sheet metal. The item 1 is conveyed by a conveyor belt 10 arranged below the decorating roller 9 along an travel direction F coinciding with the rotation direction of the decorating roller 9.

FIG. 4 shows an apparatus 11′ suitable for applying a coating material to an item 1′ provided with a surface 2′ that may be curved, as shown in FIG. 4, or not contained on a single plane, for example provided with grooves or protuberances.

The apparatus 11′ can also be used if side surfaces of section bars have to be decorated, in other words, surfaces arranged on the edges of a main surface of the section bar itself.

These side surfaces may be provided with a curved geometry as indicated in FIG. 4, or with a flat geometry.

The apparatus 11′ comprises applicator means 12 provided with an applicator roller 19 whereupon the pattern is obtained that one wishes to transfer to the item 1′. A feeding system that is not shown feeds the applicator roller 19 with a cladding material 7′, which is then applied by means of the applicator roller 19 to transfer means 14 suitable for transferring the cladding material 7′ to the surface 2′. Transfer means 14 comprises a support belt 13 of elastomeric material, for example rubber or silicon, closed in a loop, provided with a substantially continuous surface, in other words almost free of openings. The belt 13 is wound around a cylindrical drum 15 and a shaped drum 16, both of which are made to rotate in the same direction around respective rotation axes, by means of motor means not shown. The shaped drum 16 is delimited by a profile 17 substantially corresponding to the further profile 17′ of the surface 2′ and the belt 13, thanks to the deformability of the material that makes it up, adapts itself to the profile 17 in the zone of contact with the shaped drum 16. In other words, the surface of the belt 13 wound to the shaped drum 16 mates locally with the further profile 17′ of the item 1, which enables the cladding material 7′ to be transferred to any surface, no matter how complicated.

It should be noted that the cylindrical drum 15 acts as contrast means providing a rigid limit for the applicator roller 19. The cylindrical geometry of the drum 15 simplifies the application to the belt 13 of the cladding material 7′, inasmuch as it makes it possible to use a cylindrically shaped applicator roller 19 rather than one shaped in another way.

The rotation axis Z1 of the cylindrical drum 15 and the rotation axis Z2 of the applicator roller 19 are parallel to one another. In the example in FIG. 4, the rotation axis Z1 of the cylindrical drum 15 is parallel to the rotation axis Z3 of the shaped drum 16, but in principle these two axes can be no matter how arranged between each other.

For example, in FIG. 5 a preferred embodiment of the apparatus 11′ is shown wherein the rotation axis Z1 of the cylindrical drum 15 is placed on a plane at right angles to the plane of the partial section containing the rotation axis Z3 of the shaped drum 16. In this embodiment the belt 13, owing to its deformability, moves from a substantially horizontal configuration, wherein it is located when it is wound to the cylindrical drum 15, to a substantially vertical configuration wherein it is wound to the shaped drum 16 through a region 20 of modification of the position wherein the belt 13 acquires a warped configuration.

This embodiment can be used if a cladding material 7′ has to be applied in the liquid state having low values of viscosity.

In this case, providing a cylindrical drum 15 with a horizontal axis enables the risk to be reduced that the cladding material 7′ runs towards the bottom zones of the applicator roller 19 due to the force of gravity.

Naturally, different solutions can be adopted, and in particular different spatial arrangements of the drums 15 and 16, of the belt 13, and of the applicator roller 19, if particular reasons, for example of space, make this necessary. The belt 13 can transfer the cladding material 7′ to the item 1 in a uniform manner or according to a decorative pattern.

In the latter case, the belt 13 can be provided with a uniform surface, in particular smooth, whereupon the decorative pattern is formed by the applicator roller 19, for example by relief printing or gravure printing techniques.

In an embodiment that is not shown, it is also possible for the belt 13 to be externally provided with a plurality of cavities or protrusions defining the decorative pattern to be obtained on the item 1′. In this case it is sufficient to directly feed the cladding material 7′ to the belt 13 using a prior-art feeding system without having to resort to the applicator roller 19 upon whose surface the pattern to be transferred is etched.

FIG. 6 shows a portion of an apparatus 611 for decorating items, particularly section bars. The apparatus 611 comprises forward travel means 30 arranged to convey the section bars in a forward travel direction F. Forward travel means 30 may comprise a plurality of wheels 31, arranged in such a way as to define a first rest surface for a bottom surface of the section bars and a second rest surface for a lateral surface of the section bars. Alternatively, the forward travel means 30 may comprise other suitable components for conveying section bars forward in the forward travel direction F, for example one or more belts or a plurality of rollers.

During their path in the forward travel direction F, the section bars interact with transfer means comprising a silkscreen printing belt 32, a portion of which is shown in detail in FIG. 9. The silkscreen printing belt 32 is formed by a silkscreen closed in a loop and comprises permeable zones 33, provided with a plurality of openings 35 suitable for being crossed by a fluid material, for example a paint, and a plurality of impermeable zones 34 that cannot be traversed by the paint. The permeable zones 33 and the impermeable zones 34 are arranged in such a manner as to define a pattern that one wishes to apply onto the section bars, reproducing for example the veins of wood.

The silkscreen printing belt 32 may be created starting with a synthetic textile formed by thin wires, wherein the openings 35 are identified between the warp and the weft. In preset zones of the fabric it is possible to apply a resin that by closing the openings 35 creates the impermeable zones 34. If one wishes to apply onto the section bar a uniform layer of paint rather than a decorative pattern, a silkscreen printing belt 32 without impermeable zones 34 can be used that is thus permeable to the paint along its entire surface.

The silkscreen printing belt 32 travels the path shown schematically in FIG. 7. In particular, the silkscreen printing belt 32 winds around a driving pulley 36 and around a plurality of idle pulleys 37 in such a way as to travel a loop path in the direction of the arrow F1. The driving pulley 36 and the idle pulleys 37 are provided with respective vertical rotation axes so that between one pulley and the next one the silkscreen printing belt 32 extends along a vertical plane.

Applicator means 38 arranged downstream of driving pulley 36 in relation to direction F1 feeds on the silkscreen printing belt a fluid material such as a paint, as shown by the arrow F2. Applicator means 38 may comprise a pipe or nozzle arranged near a region of the silkscreen printing belt 32 located inside the loop path travelled by it.

A first doctor knife 39 and a second doctor knife 40 arranged downstream of applicator means 38 on opposite parts of the silkscreen printing belt 32 remove excess paint, thereby ensuring that the paint is deposited only inside the openings 35. In particular, the first doctor knife 39 is arranged inside the loop path travelled by the silkscreen printing belt 32, whereas the second doctor knife 40 is arranged outside said path.

Downstream of the first doctor knife 39 and of the second doctor knife 40 a third doctor knife 41 is arranged that interacts with the surface of the silkscreen printing belt 32 opposite the surface with which the second doctor knife 40 had interacted. In the case in point, the third doctor knife 41 is positioned inside the loop path travelled by the silkscreen printing belt 32, in other words on the part opposite the second doctor knife 40 positioned outside said path. The third doctor knife 41 enables any particles of paint that have been pushed to the internal surface of the silkscreen printing belt 32 by the second doctor knife 40 to be removed.

Downstream of the third doctor knife 41 a shaped doctor knife 42 is provided that is mounted on a cylindrical support 43. The shaped doctor knife 42 presses the silkscreen printing belt 32 into contact with a section bar 44 conveyed forwards in the travel direction F by forward travel means 30, not shown in FIG. 7.

As shown in FIG. 8, the shaped doctor knife 42 is delimited on the part designed to interact with the section bar 44, by a straight edge 45, provided, in its own central region, with a recess 46 that reproduces the shape of an edge zone of the section bar 44. In the example in FIG. 8, the section bar 44 to be decorated has a cross-section delimited by two straight sides 47 that are parallel to each other, and by two rounded edge zones 48 interposed between the straight sides 47. The recess 46 obtained in the shaped doctor knife 42 has a form corresponding to that of the edge zone 48 in such a way as to deform the silkscreen printing belt 32 and shape it according to the geometry of the edge zone 48 to be decorated when the shaped doctor knife 42 interacts with the section bar 44. In this way, the paint is transferred from the openings 35 of the silkscreen printing belt 32 to the edge zone 48, thereby forming on the edge zone 48 the pattern defined by the permeable zones 33.

The silkscreen printing belt 32, which is by now devoid of paint, then continues along its path, winding itself again around the drive pulley 36 and subsequently receiving new paint from feed means 38. The drive pulley 36 may be provided with a further doctor knife 49 suitable for keeping the external surface of the driving pulley 36 free from any paint residues.

The cylindrical support 43 of the shaped doctor knife 42 is movable in a direction F3 that is transversal to the forward travel direction F of the section bar 44, in such a manner as to be able to be brought up to or moved away from the silkscreen printing belt 32 by actuating means that is not shown. In particular, to reduce wear to the silkscreen printing belt 32, the shaped doctor knife 42 is pressed against the silkscreen printing belt 32 only when a section bar 44 is conveyed forwards by the forward travel means 30 to a position facing the shaped doctor knife 42.

For this purpose, sensor means 50 is provided, shown only schematically in FIG. 7, arranged near the shaped doctor knife 42 to detect the passage of a front end 51 of the section bar 44 in front of the shaped doctor knife 42. When sensor means 50 detects that the front end 51 of the section bar 44 has moved in front of the shaped doctor knife 42, it actuates forward travel means that brings up the shaped doctor knife 42 to the silkscreen printing belt 32 in the transversal direction F3 so as to press the silkscreen printing belt 32 against the edge zone 48 and decorate the latter. The silkscreen printing belt 32 is thus prevented from being pressed by the shaped doctor knife 42 against the front end 51, which could have cutting edges formed during the initial cutting operations of the section bar 44. Said edges could lacerate the screen belt 32 if the shaped doctor knife 42 is maintained constantly adhering to the silkscreen printing belt 32.

The excess paint delivered by applicator means 38 is collected in a drip-tray 70 arranged below the path of the silkscreen printing belt 32 and indicated in FIG. 7 with a dotted line for the sake of clarity of representation and is then again sent to applicator means 38 by means of a pump that is not shown.

The apparatus 611 shown in FIGS. 6 and 7 thus enables edge zones of section bars or other items to be decorated, that is zones situated on the edges of a main face that may be previously or subsequently decorated using prior-art techniques. For example, in the case of the section bar 44, the edge zones 48 can be decorated by having the section bar 44 passed twice inside the apparatus 611, in such a way that the shaped doctor knife 42 and the silkscreen printing belt 32 interfere first with an edge zone 48 and then with the other edge zone 48. The flat faces of the section bar 44 can be decorated before or after decorating the edge zones 48 using a prior-art apparatus. It is also possible for not all the faces of the section bar 44 to be decorated. If, for example, only some faces of the section bar 44 are intended to remain visible during use of the section bar, it is possible to decorate only the operationally visible faces.

Instead of the shaped doctor knife 42 it is possible to use a pulley whereupon the silkscreen printing belt 32 is wound, the pulley having a profile mating with the profile of the section bar 44. The pulley acts as doctor knife means, inasmuch as it removes the paint from the openings 35 and transfers it to the section bar 44.

FIG. 10 shows an apparatus 1011 for decorating items, in particular section bars 44.

The apparatus 1011 has a structure that is similar to that of the apparatus 11 shown in FIG. 3. The section bar 44 is conveyed forwards along a travel direction that is perpendicular to the plane of the FIG. 10 owing to forward travel means comprising a conveyor belt 52 wound as a loop around a plurality of pulleys 53, only one of which is shown in FIG. 10. During its path, the section bar 44 interacts with a transfer roller 54 that applies a paint to a surface portion 55 of the section bar 44. The paint is applied to the transfer roller 54 by means of an engraved roller that is not shown that cooperates with a doctor knife, which is also not shown. The transfer roller 54 is provided with an elastically deformable external layer, which can be for example made of rubber or silicon. Below the external layer a yielding intermediate layer may be provided, for example of a spongy type, suitable for increasing the deformability of the external layer. The intermediate layer is fitted to a rigid support structure made, for example, of metal or plastics material.

Owing to its deformability, the transfer roller 54 is deformed as it comes into contact with the section bar 44 and is then able to decorate a surface portion 55 comprising not only a flat portion 56 of the section bar 44, but also two edge portions 57 adjacent to the flat portion 56.

If one wishes to decorate the entire surface of the section bar 44, after decorating the surface portion 55 as indicated in FIG. 11, it is possible to rotate the section bar 44 by 180° around its own longitudinal axis and again insert the section bar 44 inside the apparatus 1011, in such a way that a further surface portion 58 opposite the surface portion 55 interacts with the transfer roller 54. The further surface portion 55 comprises a further flat portion 59, opposite the flat portion 56, and two further edge portions 60 arranged on opposite parts of the further flat portion 59 and adjacent to the already decorated edge portions 57. In this way, with two passages of the section bar 44 inside the apparatus 1011, it is possible to decorate the entire surface of the section bar 44.

Owing to the deformability of the transfer roller 54, it is also possible to decorate surfaces provided with steps, recesses or zones in relief.

In the example in FIG. 10, the transfer roller 54 is provided with a smooth external surface. The engraved roller cooperating with the transfer roller 54 is on the other hand provided with a surface whereupon a pattern is engraved that one wishes to transfer to the section bar 44. This pattern can be defined by a plurality of cavities obtained on the engraved roller, in which case the latter operates according to a gravure printing principle, or by a plurality of reliefs obtained on the engraved roller, which operates according to a relief printing principle.

In an alternative embodiment, the engraved roller can transfer to the transfer roller 54 a uniform layer of paint, if one wishes to apply the paint in a uniform manner onto the section bar 44 without defining particular patterns.

The apparatus 1011 can also be used for decorating only a part of the surface of a section bar, as shown in FIG. 12. In this case, one wishes to decorate a section bar 44′ provided with a substantially square cross-section with rounded corners. The transfer roller 54, owing to its deformability, enables the top flat surface 61 and the top rounded corners 62 of the section bar 44′ to be decorated. If the other zones of the section bar 44′ are not intended to remain visible during use of the section bar 44′, further decorating operations are not necessary. Otherwise, it is possible, for example, to rotate the section bar by 180° and reinsert it in the apparatus 1011 for decorating the bottom flat surface 63 and the bottom rounded corners 64, whilst the bottom side surfaces 65 can be decorated by means of traditional apparatuses.

1-66. (cancelled)

67. Apparatus comprising a transfer arrangement suitable for coming into contact with a shaped surface of an item to transfer thereupon a fluid material and an applicator device suitable for applying said fluid material onto said transfer arrangement, wherein said transfer arrangement is deformable so as to be able to adapt itself according to said shaped.

68. Apparatus according to claim 67, and further comprising a pressing device arranged to press said transfer arrangement against said shaped surface.

69. Apparatus according to claim 68, wherein said pressing device is delimited by a profile mating with a further profile of said shaped surface.

70. Apparatus according to claim 68, wherein said transfer arrangement comprises a belt device.

71. Apparatus according to claim 70, wherein said belt device comprises a silkscreen printing belt device closed in a loop.

72. Apparatus according to claim 71, wherein said silkscreen printing belt device is wound on a pulley device with a vertical axis.

73. Apparatus according to claim 71, wherein said silkscreen printing belt device is provided with zones permeable to said fluid material adjacent to zones impermeable to said fluid material.

74. Apparatus according to claim 71, wherein said pressing device comprises a doctor blade device.

75. Apparatus according to claim 74, wherein said doctor blade device is delimited by a substantially straight edge provided with a recess suitable for being pressed in a shapingly coupled manner against an edge zone of said item.

76. Apparatus according to claim 74, and further comprising an actuating arrangement arranged for selectively bringing up said doctor blade device to, or removing said doctor blade device from, said item.

77. Apparatus according to claim 76, and further comprising a sensor element arranged to detect movement of a front end of said item near said doctor blade device.

78. Apparatus according to claim 71, and further comprising a further doctor blade device arranged to remove an excess of said fluid material from said silkscreen printing belt device.

79. Apparatus according to claim 78, wherein said further doctor blade device comprises a first doctor blade device and a second doctor blade device arranged on opposite parts of said silkscreen printing belt device.

80. Apparatus according to claim 68, wherein said transfer arrangement comprises substantially a continuous belt support device.

81. Apparatus according to claim 80, wherein said belt support device is delimited by a substantially smooth external surface.

82. Apparatus according to claim 80, wherein said belt support device is externally provided with a plurality of corrugations arranged according to a preset pattern.

83. Apparatus according to claim 80, wherein said pressing device comprises shaped drum elements whereupon said belt support device is wound.

84. Apparatus according to claim 83, wherein said shaped drum element is rotatable around a first axis.

85. Apparatus according to claim 84, and further comprising a return device extending along a second axis, said belt support device winding to said return device.

86. Apparatus according to claim 85, wherein said first axis is substantially parallel to said second axis.

87. Apparatus according to claim 85, wherein said first axis is tilted in relation to said second axis.

88. Apparatus according to claim 85, wherein said second axis lies on a substantially horizontal plane.

89. Apparatus according to claim 85, wherein said return device comprises cylindrical drum element.

90. Apparatus according to claim 85, wherein said applicator device is positioned in such a way as to apply said fluid material onto said belt support device near said return device.

91. Apparatus according to claim 67, wherein said transfer arrangement comprises a transfer roller device.

92. Apparatus according to claim 91, wherein said transfer roller device is provided with an elastically deformable external layer.

93. Apparatus according to claim 92, wherein said transfer roller device comprises a spongy layer arranged inside said external layer.

94. Apparatus according to claim 91, wherein said transfer roller device is provided with a substantially smooth external surface.

95. Apparatus according to claim 67, wherein said applicator device comprises an applicator roller device.

96. Apparatus according to claim 67, wherein said applicator device is configured in such a way as to operate according to a gravure printing principle.

97. Apparatus according to claim 67, wherein said applicator device is configured in such a way as to operate according to a relief printing principle.

98. Method comprising bringing a transfer arrangement into contact with a shaped surface of an item to transfer a fluid material from said transfer arrangement onto said shaped surface, wherein during said transferring said transfer arrangement is deformed to adapt itself to said shaped surface.

99. Method according to claim 98, and further comprising pressing said transfer arrangement against said shaped surface during said transferring.

100. Method according to claim 99, wherein said pressing comprises modifying the form of said transfer arrangement to make them mate with said shaped surface.

101. Method according to claim 98, and further comprising moving forward said item in a forward travel direction to make said item interact with said transfer arrangement.

102. Method according to claim 101, and further comprising detecting the passage of a front end of said item to a position wherein said transfer arrangement interacts with said item.

103. Method according to claim 102, wherein said pressing occurs after said detecting.

104. Method according to claim 98, wherein said transferring comprises forming on said item a pattern defined by said fluid material.

105. Method according to claim 98, wherein during said transferring said transfer arrangement interacts with surface zones of said item arranged on different planes.

106. Method according to claim 98, wherein during said transferring said transfer arrangement interacts with edge zones of said item.

107. Method according to claim 106, wherein said edge zones comprise curved surfaces.

108. Method according to claim 98, and further comprising, after said transferring, rotating said item around its own axis.

109. Method according to claim 108, wherein after said rotating further bringing said item into contact with said transfer arrangement is provided for to further transfer said fluid material to a further surface of said item distinguished by said shaped surface.

110. Method according to claim 109, wherein said further surface is adjacent to said shaped surface.

111. Method according to claim 108, wherein said rotating comprises rotating by 180°.

112. Method according to claim 98, wherein said fluid material comprises a paint that is settable by means of UV rays.

113. Method for decorating an item, comprising distributing onto said item polymeric base layer elements, applying onto said base layer elements a decorative pattern defined by decorating elements in liquid form, fixing said decorative pattern to said item, wherein said fixing comprises anchoring said decorating elements to said base layer elements, without applying onto said item further fixing layers.

114. Method according to claim 113, wherein said base layer elements is applied to said item in powder form.

115. Method according to claim 113, wherein said base layer elements is applied to said item in liquid form.

116. Method according to claim 113, wherein said base layer elements comprises thermosetting material.

117. Method according to 113, wherein said fixing comprises partial firing said base layer elements.

118. Method according to claim 117, wherein said partial firing comprises heat treating said base layer elements at temperatures substantially comprised between 40° C. and 180° C.

119. Method according to claim 118, wherein said heat treating occurs at a temperature of about 170° C.

120. Method according to claim 117, wherein said partial firing comprises heating said base layer elements for a time of about 10 minutes.

121. Method according to claim 113, wherein said decorating elements comprise a further thermosetting material.

122. Method according to claim 113, wherein said decorating elements comprise a paint that is settable through exposure to UV rays.

123. Method according to claim 113, wherein said fixing comprises polymerising together said base layer elements and said decorative pattern in a substantially complete manner.

124. Method according to claim 123, wherein said polymerising comprises subjecting said base layer elements to temperatures substantially comprised between 180° and 220° C.

125. Method according to claim 123, wherein said polymerising comprises providing heat for said base layer elements for a time substantially comprised between 10 and 40 minutes.

126. Method according to claim 113, wherein said applying comprises using relief printing techniques.

127. Method according to claim 113, wherein said applying comprises using gravure printing techniques.

128. Method according to claim 98, wherein said item comprises a section bar.

129. Method according to claim 113, wherein said item comprises a section bar.

130. Method according to claim 98, wherein said item comprises a sheet of sheet metal.

131. Method according to claim 113, wherein said item comprises a sheet of sheet metal.

132. Use of a gravure printing technique for decorating section bars.

133. Use of a relief printing technique for decorating section bars.

134. Use of a paint that is settable by means of UV rays for decorating a section bar.
